(19) United States
(12) Patent Application Publication
(10) Pub. No.: US 2022/0186512 A1
(43) Pub. Date: Jun. 16, 2022

(54) ELONGATED POOL RETURN FOR HIGH VOLUME, LOW VELOCITY FLOW

(71) Applicant: Mark Carl Krawczyk, Green Cove Springs, FL (US)

(72) Inventor: Mark Carl Krawczyk, Green Cove Springs, FL (US)

(21) Appl. No.: 17/644,148

(22) Filed: Dec. 14, 2021

Related U.S. Application Data
(60) Provisional application No. 63/199,205, filed on Dec. 14, 2020.

(51) Int. Cl. E04H 4/12; B05B 1/04

(52) U.S. Cl. CPC E04H 4/12; B05B 1/044

(57) ABSTRACT

An elongated pool return for achieving high flow rates at low velocities is herein disclosed. The pool return generally includes an elongated main body and a slot box. In use, the pool return is mounted within a side wall of a pool such that a distal end of the slot box is exposed from the side wall, and fluid is permitted to flow into and through the main body, through the elongated slit, and through the slot opening, and into an opening of the pool. Because the pool return is elongated, large amounts of water can be displaced at low velocities.

### CROSS-REFERENCE TO RELATED APPLICATION

This application claims the benefit of priority of U.S. provisional application No. 63/199,205, filed Dec. 14, 2020, the contents of which are herein incorporated by reference.

### BACKGROUND OF THE INVENTION

The present invention relates to pool returns and, more particularly, to an underwater in wall slot pool return that introduces water flow into a pool at high volume with low flow velocity.

Conventional pool return systems are not capable of introduction of water flow into a swimming pool at high flow rates and at low flow velocities. By way of example, in conventional systems, floor inlets require multiple returns at 25 gallons per minute (GPM) to accomplish pool overflow. They require piping loops and pipe risers that are unsightly on the pool floor.

Additionally, there are higher labor costs associated with installing multiple floor inlets in a pool. Floor inlets accomplish the flow needed, but they are not aesthetically pleasing to the eye as they litter the floor with numerous returns and are not flush with the pool floor and thus uncomfortable to step on when walking in the pool. Further, floor inlet returns require balancing of the multiple returns, adding complexity to the system.

As can be seen, there is a need for an underwater in wall slot pool return that introduces water flow into a pool at high volume with low flow velocity.

### SUMMARY OF THE INVENTION

In one aspect of the present invention, a pool return is provided that is configured for use with a pool. The pool return comprises a main body and a slot box. The main body is configured to couple to at least one inlet pipe of a pool pump system, has an elongated length and defines an elongated slit through a side surface thereof in a direction of the elongated length. The slot box is coupled to the main body such that the slot box overlays the elongated slit. Further, the slot box defines a slot opening. In use, the main body and slot box are mounted within a side wall of a pool such that a distal end of the slot box is exposed from the side wall, and fluid is permitted to flow into and through the main body, through the elongated slit, and through the slot opening, and into an opening of the pool.

In another aspect of the present invention, a pool system is provided that comprises a pool, a pool pump system, and a pool return. The pool comprises a side wall that at least partially defines a pool opening. The pool pump system comprises at least one inlet pipe and is configured to pump fluid. The pool return is mounted within the side wall of the pool and comprises a main body and a slot box. The main body is coupled to the at least one inlet pipe, has an elongated length, and defines an elongated slit through a side surface thereof in a direction of the elongated length.

The slot box is coupled to the main body such that the slot box overlays the elongated slit. Further, the slot box defining a slot opening, with a distal end of the slot box being exposed from the side wall. In use, the fluid being permitted to flow from inlet pipe, into and through the main body, through the elongated slit, and through the slot opening, and into the pool opening.

In certain embodiments, the elongated length is at least twelve inches long.

In certain embodiments, the elongated length is approximately three feet.

In certain embodiments, the pool return further comprises a diverter plate mounted in the main body, with the diverter plate defining a plurality of openings

In certain embodiments, the main body is substantially circular or rectangular in cross section along the direction of the elongated length. These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in-use;

FIG. 2 is a perspective view of the embodiment of the present invention;

FIG. 3 is an exploded view of the embodiment of the present invention;

FIG. 4 is a partial section view taken along line 4-4 from FIG. 1;

FIG. 5 is a perspective view of an alternate embodiment of the present invention; and

FIG. 6 is a section view taken along line 6-6 from FIG. 5.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, an embodiment of the present invention provides a pool return designed for installation in a lower region of a pool. Further, the pool return includes an elongated body and an elongated return slot being formed in the elongated body.

The present invention eliminates the use of numerous swimming pool floor inlets which provide flow into swimming pool. The present invention also reduces labor costs associated with the installation of multiple floor inlets and piping by using one fixture to accomplish the same. This eliminates multiple pipe penetrations through the pool floor, which can otherwise result in potential leak issues. In accordance with certain aspects of the present invention, rather than swimming pools that use wall and floor inlets to introduce water into swimming pool, the slot return of the present invention uses one fixture to accomplish the introduction of high-volume flow at low flow velocity with no surface disturbance. It may be used with, for example, but is not limited to, an overflow pool, a vanishing edge pool, or other perimeter overflow.

The present invention improves the aesthetics of the pool, in part, by eliminating unsightly floor returns scattered over pool floor. Due to the unique design, pool floors incorporating embodiment of the present invention are free of numerous returns in the floors. Further, there are no floor returns to step on. Consequently, the pool floor is smooth without unsightly floor returns. Optionally, an additional diverter may be used inside embodiments of the present invention to even flow rate across a length of box as needed.

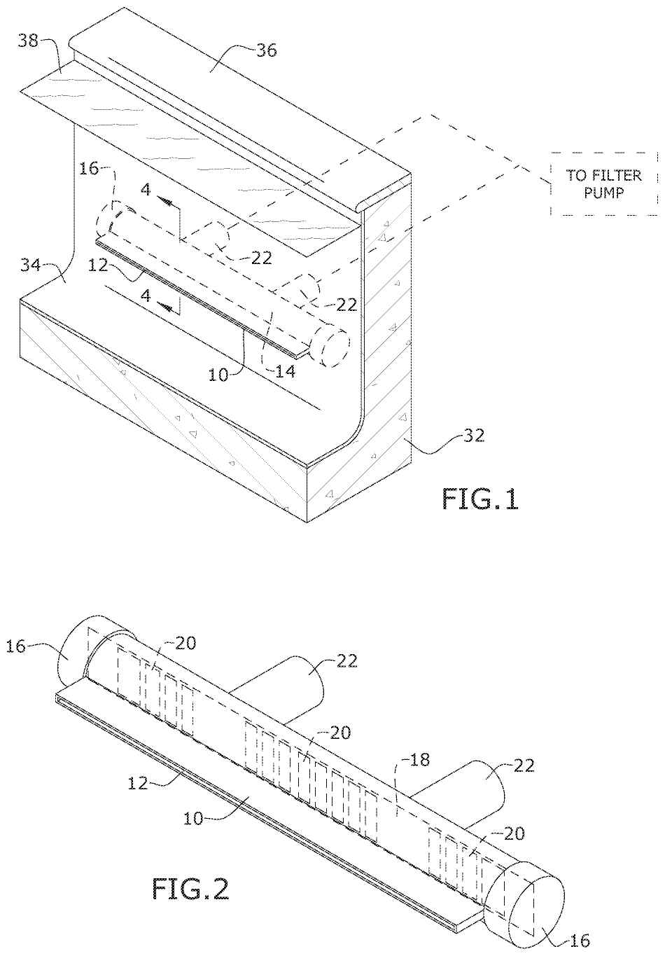

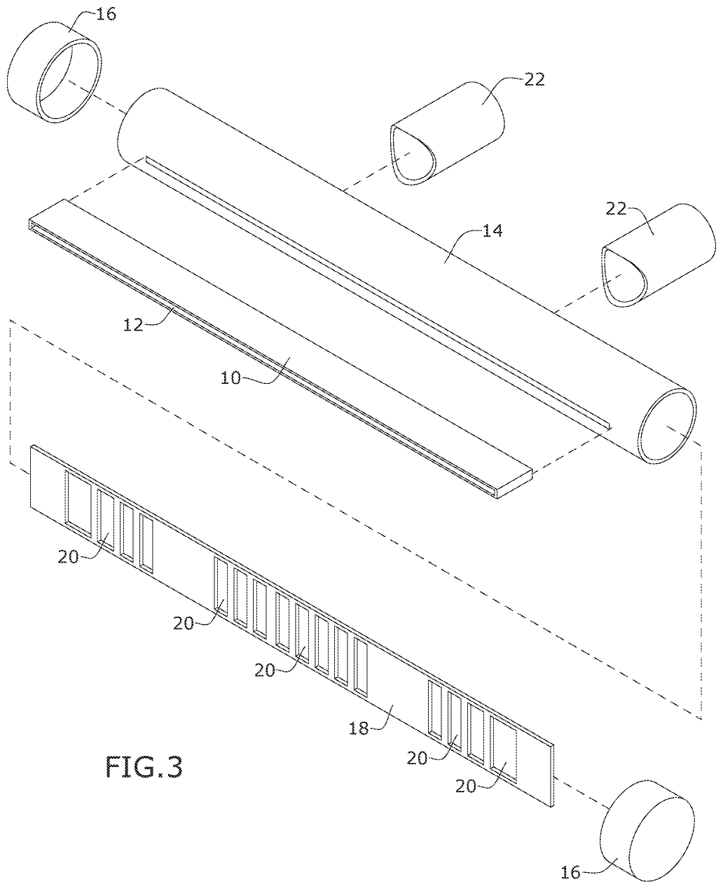

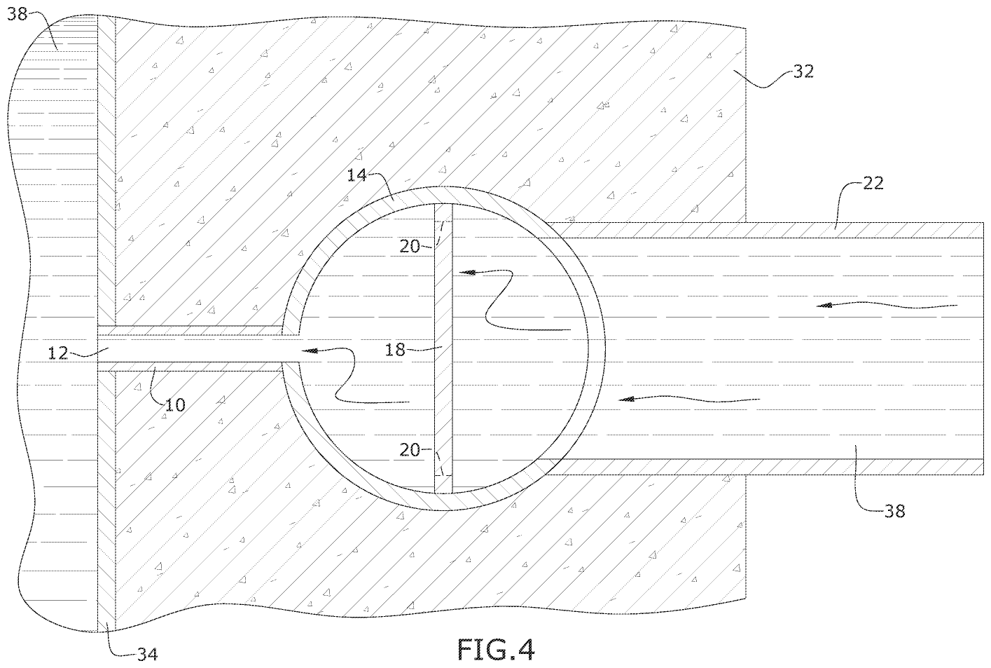

Making reference to FIGS. 1-4, a first embodiment of a pool return is shown. The pool return includes a pipe 14 forming a main elongated body of the return. As shown in FIG. 2, the elongated body is elongated relative to one or more inlet pipes 22 that are coupled thereto. The main body generally defines a main body opening through which fluid flows. The opening functions, in part, as a chamber in which the flow velocity of the pool water is reduced. By way of example, the pipe 14 may be 4 inches in diameter, approximately 3 feet long, and formed from polyvinyl chloride (PVC). However, it will be appreciated by those with skill in the art that the pipe 14 may be formed in a variety of dimensions. As shown in FIG. 3, it defines an elongated slit on a side surface thereof. The slit may be approximately 1.125 inches tall to accommodate a slot box 10 therewithin (described in greater detail below). End caps 16 are permanently attached to distal ends of the pipe 14 to seal the fixture. A slot box 10 is permanently attached, such as via welding, to the pipe 14 within the above-described slit formed in the pipe 14 (e.g., see FIGS. 3 and 4). By way of example, the slot box 10 may be approximately 1.125 inches tall, three feet long, and 8 inches deep (the direction directed horizontally left and right in FIG. 4). The slot box 10 defines a slot opening 12 which functions as a fluid outlet, in use. The slot opening 12, in certain embodiments, may be approximately no greater than ⅜ inches in height. This height is large enough to allow sufficient fluid flow therethrough, while not being large enough for a finger to be inserted into the slot box 10. One or more inlet pipes 22 (which may be, e.g., 8 inches in diameter) are attached to the pipe 14. In certain embodiments, the inlet pipe(s) 22 may be disposed opposite the slot box 10, as shown in FIG. 2, and operably connect to a water pump of a pool pump system (the pool return being a part of this system).

This pool return, once fully assembled, can be embedded into the concrete 32 proximal a bottom surface of the pool, with the slot opening 12 flush to the finished surface 34 of the pool. The slot box 10 is designed to be flush to or extend beyond the pool finish and be cut flush to pool finish to adapt to straight and curved surfaces (which is typically filled with water 38 and includes a coping 36 at a top portion thereof around a perimeter of the pool).

Further, a diverter plate 18 may be embedded into the pipe 14, with the diverter plate 18 defining diverter openings 20 (e.g., the openings 20 may be approximately 3 inches in width) therewithin. In use, the diverter plate 18 blocks fluid lateral fluid flow through the pipe 14 in certain directions, and permits it in regions that have the diverter openings 20. Thus, fluid flow can be tweaked while using the same general design of the pipe 14 and slot box 10. The plate 18 may be embodied as, for example, ¼ inch thick PVC sheet made via a computer numerical control (CNC) machine.

Various modifications to the embodiment described above may be made in accordance with the present invention. Those with skill in the art will appreciate that, while the pipe 14 is described as circular in cross-section, it does not necessarily need to be formed in this manner. For example, it could be rectangular.

Further, the components could be formed from other materials that are usable in concrete and resistant to pool water chemicals, such as stainless steel or other metals. The dimensions and number of connected pool returns may be adjusted as required by the specific pool application. In use, the pipe 14 handles high volume flow rates from the inlet pipe(s) 22. The slot opening 12, when using the exemplary dimensions described above, provides approximately 3-4 gallons per minute (GPM) per inch at 4 feet per second (FPS) or less. The diverter plate 18, with its openings 20, direct flow to the slot box 10 to evenly spread the flow rate along the length of the slot box 10, no matter where the inlet pipe(s) 22 are positioned. The elongated pipe 14 and corresponding elongated slot box 10 allow for high volume flow rates into the pool at reduced velocities (relative to conventional designs). The end caps 16 seal ends of the pipe 14 to make it a sealed unit. Alternatively, as needed, one end, instead of using an end cap 16, may utilize may use a coupling to join additional pool returns together. Advantageously, the underwater pool return assembly described herein may be used by pool builders and installers to provide high flow rates from a single fixture in the wall of the pool near the pool floor. This reduces labor and cost of additional materials and hours of labor associated with the installation of additional piping loops, risers and fittings in the floor of the pool (as otherwise required with conventional systems). Further, this pool return eliminated/reduces the need for floor penetrations which can result in possible leaks in the pool floor.

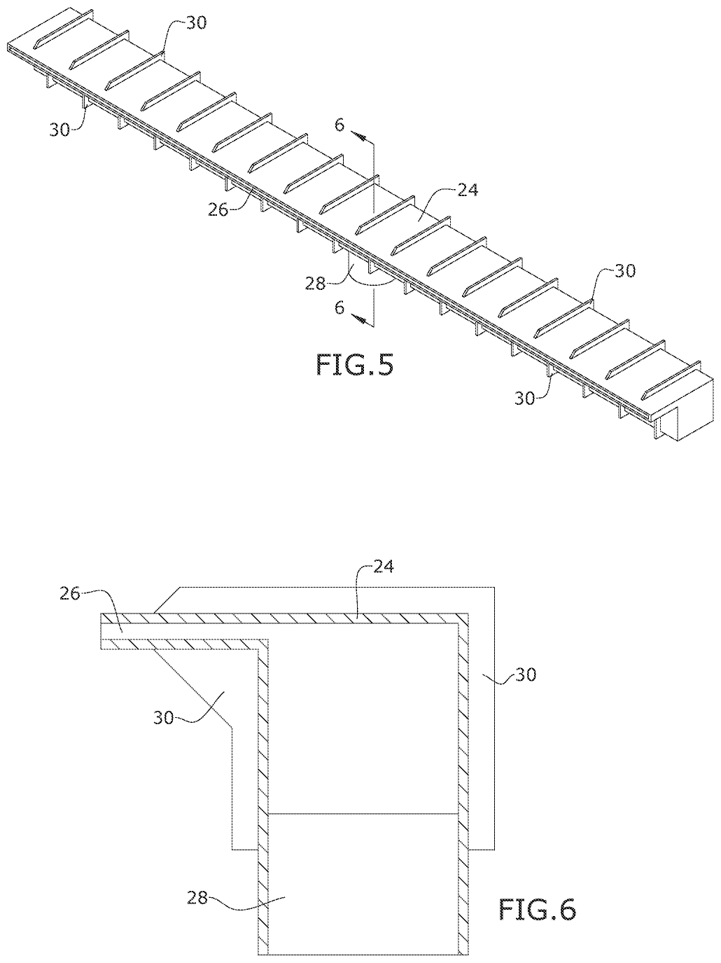

Referring now to FIGS. 5-6, an alternative embodiment, similar to the one described above, is generally shown. The pool return includes an enclosed box 24, which may define a thickened wall. In certain embodiments, the thickened wall may be, for example, ⅜″-¼″ (note that the unit inch and the symbol ″ are synonymous) thick acrylonitrile butadiene styrene (ABS) plastic. The enclosed box 24 may include reinforcing ribs 30 for installation underwater in a pool concrete wall 32 and fastening to in-wall steel reinforcing. An open water return slot 26 (which may be, for example, ¼ to ⅜″) is provided to extend to the pool finish material while providing only a ¼″ visible return slot 26. A slot design and length of the pool return may be varied depending upon water flow volume required. For example, a 72″ slot return provides 18″ of total open area for flow rates up to 216 GPM (3 GPM per inch). One or more supply lines 28 (for example, two 4″ supply lines 28) may provided for even distribution through the slot return manifold, providing high flow at low velocity entering the swimming pool near floor level.

Embodiments of the present invention replace and are an improvement on the use of multiple swimming pool floor inlets, piping loops, installation costs, labor costs and time, and increases pool aesthetics by removing excess floor inlets. The present invention is configured specifically to allow higher volume flow (for example, by use of the reinforced ribbing) and be installed at or near the base/floor of the pool. It will be appreciated by those with skill in the art that any dimensions described herein and shown in the figures are exemplary and should not be construed to narrow the patent unless explicitly stated. Embodiments of the present invention are designed for fabrication from a PVC fabricator. Certain embodiments of the present invention may be fabricated from ABS polyvinyl chloride (PVC) plastic. Once fabricated, embodiments of the present invention may be shipped to a pool location, and installed in a wall of the pool, near the pool floor with a, for example, 4-inch water supply line installed/provided.

While certain methods of making the present invention have been described above, other methods making the present invention may include the following. Embodiments of the present invention may be fabricated by PVC fabricators. The overall unit length and slot width may vary depending on the flow rate required. In certain embodiments, the length could vary from 12 inches all the way up to 72 inches.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

What is claimed is:

1. A pool return configured for use with a pool, the pool return comprising:
a main body configured to couple to at least one inlet pipe of a pool pump system, the elongated main body having an elongated length and defining an elongated slit through a side surface thereof in a direction of the elongated length; and
a slot box coupled to the main body such that the slot box overlays the elongated slit, the slot box defining a slot opening, and
in use, the main body and slot box are mounted within a side wall of a pool, at a lower portion thereof, such that a distal end of the slot box is exposed from the side wall, and fluid is permitted to flow into and through the main body, through the elongated slit, and through the slot opening, and into an opening of the pool.

2. The pool return of claim 1, wherein the elongated length is at least twelve inches long.

3. The pool return of claim 1, wherein the elongated length is selected within the range of approximately three feet to six feet.

4. The pool return of claim 1, further comprising a diverter plate mounted in the main body, with the diverter plate defining a plurality of openings.

5. The pool return of claim 1, wherein the main body is substantially circular or rectangular in cross section along the direction of the elongated length.

6. A pool system comprising:
a pool comprising a side wall that at least partially defines a pool opening;
a pool pump system comprising at least one inlet pipe and configured to pump fluid; and
a pool return mounted within the side wall of the pool, at a lower portion thereof, the pool return comprising:
a main body coupled to the at least one inlet pipe, the elongated main body having an elongated length and defining an elongated slit through a side surface thereof in a direction of the elongated length; and
a slot box coupled to the main body such that the slot box overlays the elongated slit, the slot box defining a slot opening, with a distal end of the slot box being exposed from the side wall, and
in use, the fluid being permitted to flow from inlet pipe, into and through the main body, through the elongated slit, and through the slot opening, and into the pool opening.

7. The pool system of claim 6, wherein the elongated length is at least twelve inches long.

8. The pool system of claim 6, wherein the elongated length is approximately three feet.

9. The pool system of claim 6, further comprising a diverter plate mounted in the main body, with the diverter plate defining a plurality of openings.

10. The pool system of claim 6, wherein the main body is substantially circular or rectangular in cross section along the direction of the elongated length.
